(19) United States
(12) Patent Application Publication
(10) Pub. No.: US 2011/0157302 A1
(43) Pub. Date: Jun. 30, 2011

(54) THREE-DIMENSIONAL VIDEO DISPLAY SYSTEM WITH MULTI-STREAM SENDING/RECEIVING OPERATION

(75) Inventor: David Glen, Toronto (CA)

(73) Assignee: ATI Technologies ULC, Markham (CA)

(21) Appl. No.: 12/695,783

(22) Filed: Jan. 28, 2010

Related U.S. Application Data
(60) Provisional application No. 61/291,080, filed on Dec. 30, 2009.

(51) Int. Cl. H04N 13/00

(52) U.S. Cl. 348/42; 348/E13.001

(57) ABSTRACT

A three-dimensional processing circuit includes a multi-stream 3D image sender that produces packet based multi-stream information that includes a first stream that has first eye view information, such as left eye frame information and a second stream that includes corresponding second eye view information, such as right eye frame information, for display on a single display, wherein each stream comprises a same object viewed from differing view perspectives. In one example, the multi-stream information is communicated as packetized data over a single cable, for example wherein a packet includes both the left eye and right eye information. In addition, the encoder provides as part of the multi-stream information, control information indicating that the first and second streams are for a single display. In one example, the multi-streams are communicated concurrently so that the single display can display stereoscopic left and right eye frame information. A corresponding receiver is also disclosed that decodes the packet based multi-stream information and combines the decoded left eye frame information and corresponding right eye information for a 3D viewing effect. In one example this may be based on control information associated with the packet based multi-stream information. Related methods are also set forth.

### CROSS-REFERENCE TO RELATED APPLICATION

The present patent application claims priority from and the benefit of U.S. Provisional Patent Application No. 61/291,080, filed Dec. 30, 2009, and entitled THREE-DIMENSIONAL VIDEO DISPLAY SYSTEM WITH MULTI-STREAM SENDING/RECEIVING, which is hereby incorporated herein by reference in its entirety.

### BACKGROUND OF THE DISCLOSURE

The disclosure relates generally to three-dimensional video systems that present 3D video images on a display screen, such as, but not limited to, stereoscopic based three-dimensional video systems.

The Display Port 1.2 standard is being proposed which is a digital interface to connect with monitors (displays). The Display Port 1.2 standard is believed to employ multi-streaming of different video streams for multiple monitors so that a hub or computer may provide differing display streams to differing monitors. As such, a single cable or wireless interface may be employed.

Display Port 1.2 may employ multiple independent display streams that are interleaved. As such, a few pixels for each monitor may be interleaved in packets that may be generated by an encoder. On the receiving end, each separate display receives and decodes its own set of packets. Also, one display may be a branch device or hub that receives streams for multiple displays (e.g., sink/logical branch), such a sink typically processes one or more streams stream and passes through the rest of the streams to other sinks/devices. There is identification data to identify subcomponents of a packet so that bytes from a packet may be identified to correspond to the same stream and hence the same monitor. One packet can include pixels for multiple displays. One display (e.g., video sink device) may also be set up as a logical branch device that receives multiple streams and displays multiple streams as separate streaming video streams, each having different images. A unique address is assigned to each logical sink in the logical branch device and a common global universal ID (GUID) is used for the logical sinks.

3D movies or videos are known that often require a user, for example, to utilize 3D eye wear so that the user gets the perception of a 3D image or scene. Stereoscopic 3D display systems employ two images, one for the left eye and one for the right eye. Also, multiple view angles may also be provided to give perceived viewing of an image from different angles. Such systems may employ, for example, a parallax screen.

Stereoscopic 3D viewing systems may send frames sequentially so that an image for a right eye is transmitted and then the image for a left eye is transmitted. Alternative left and right eye images are presented at, for example, 30 Hz rates. Shutter glasses can be employed, or polarized glasses may be employed where horizontal and vertical polarization in the glasses may be used to view 60 Hz alternating left and right eye frames that are displayed. It is also known to have a source send a receiver such as a monitor, two left and right images together as one frame with images combined. Also, frames can be sent, for example, side by side. The receiver at the monitor end receives the side by side frames and effectively cuts up the display sequentially. On the transmit side, stereoscopic images may be separated such as left and right eye viewing frames. Viewing frames may be formatted in checkerboard patterns, alternating columns, alternating rows, and alternating frames. The receivers typically must receive and scale the image but it can be difficult where only half of an image is sent at a time. Where the image source renders the image, such as a 3D game, as rendered by a 3D graphics engine, it is known to render a left and right eye image. Typically only half the information is sent for each eye which can reduce image quality or make it difficult to do independent eye view processing in the display device, among other issues. Other systems may send full information for each eye but may be disadvantaged by waiting for the second stream to be received before processing the first stream, among other issues.

Blending of left and right eye frames on the sender side is also known. However, such operation requires the blending on the transmit side of the left and right view frames before sending. This also typically requires that the source that is sending the stereoscopic information to know how to render the stereoscopic information to be consistent with the 3D display technology type of the monitor. It is also known to send left and right eye frame information in a single stream, to a single display in a checkerboard sequence wherein partial resolution left eye information and right eye information is sent at different times. Typically only half the information is sent for each eye which can reduce image quality or make it difficult to do independent eye view processing in the display device, among other issues.

It is also known to have two separate links or cables, wherein each cable or link carries separate left and right eye information. However, this requires two connectors on either end and two cables. The transmitter for example, sends the full left and right frame information and the receiver reformats the frame information according to the type of display. As such, the receiver can reformat the received frames such as changing the scale of the image if desired or format the image to be checkerboarded with corresponding left eye and right eye checkerboards. However, such systems require multiple cables which can result in additional unnecessary costs and more noise susceptibility. In addition, it is known that the multiple views for a 3D display system need not be left and right eye views but may be for a display where one frame contains color data and the other frame is a polarization information for polarization display technology.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of a three-dimensional source unit operative to generate stereoscopic multi-stream information for a single display unit in accordance with one example set forth in the disclosure;

FIG. 2 is a flowchart illustrating one example of a method for encoding a 3D image using left and right eye frames into multi-stream packets and control information in accordance with one embodiment set forth in the disclosure;

FIG. 3 is a block diagram illustrating one example of a single display multi-stream 3D image sender in accordance with one example set forth in the disclosure;

FIG. 4 is an example of a receiving unit that receives a multi-stream 3D encoded frame in accordance with one example set forth in the disclosure; and

FIG. 5 is a flowchart illustrating one example of a method for encoding left and right eye frames to produce packet based multi-stream information for a single display in accordance with one example set forth in the disclosure.

### DETAILED DESCRIPTION OF THE PREFERRED EMBODIMENTS

Briefly, a three-dimensional processing circuit includes a multi-stream 3D image sender (e.g., transmitter) that produces packet based multi-stream information that includes a first stream that has first eye view information, such as left eye frame information or polarized image information, and a second stream that includes corresponding second eye view information, such as right eye frame information, for display on a single display, wherein each stream comprises information for a same object viewed from differing view perspectives. In one example, the multi-stream information is communicated as parallel packetized data over a single cable, for example wherein a packet includes both the first and second eye view information, such as but not limited to left eye and right eye information. In another example, the image sender provides as part of the multi-stream information, control information indicating that the first and second streams are for a single display. The multi-streams are communicated concurrently over a single cable or single radio frequency channel, for example, (e.g., either in the same packets or different packets) so that the single display can display stereoscopic left and right eye frame information. A corresponding receiver is also disclosed that processes the packet based multi-stream information to provide a 3D display effect for a given type of 3D display system. By way of example, in one example, left eye and right eye frame information is combined (e.g., temporally or spatially as known in the art) into a single 3D display frame (e.g., 3D perceived image). Auto configuration of the display is provided so that the display reports to the source (e.g., via EDID or other method) that it is capable of a 3D display mode (in addition to or instead of a 2D mode). The source may also receive a mode change command to change from a 3D mode to a 2D mode or vice versa and change from outputting 2D information to outputting 3D information or vice versa in real time. Related methods are also set forth.

Among other advantages, in one example, a single cable or wireless link can be used to send left eye and right eye view information, such as stereoscopic three-dimensional image information to a single display wherein the single display can readily decode left and right eye image information in parallel and display it on a single monitor or screen. Multiple single displays may also be employed in a 3D display system. Multiple cables are not required and if desired, the display may communicate capability information back to the source unit or encoder so that the encoder can encode the stereoscopic frame information in a way that may be more simply decoded on the receiving end.

In one example, the first eye view information and second eye view information are separate streams but packetized as a multi-stream format over a single link. A single packet may include both first eye and second eye view information.

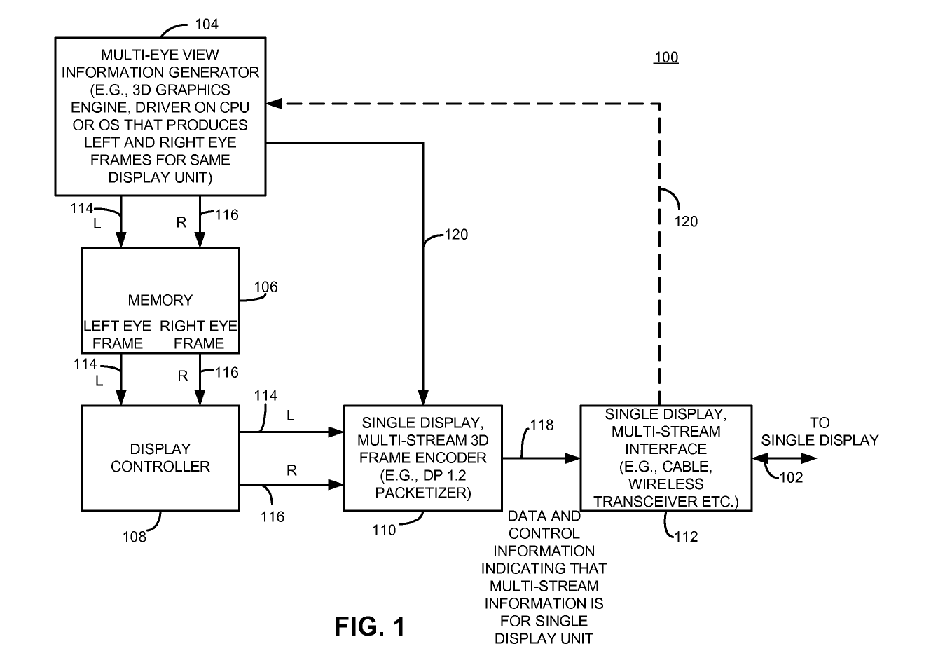

FIG. 1 illustrates one example of a three-dimensional image source unit 100 that is operative to send packet based multi-stream information 102 to a 3D image receiving unit (not shown). The 3D image source unit 100 may be any suitable device, for example, a laptop computer, desktop computer, handheld device, blue ray player, gaming console, set top box or any other suitable device. In this example, the 3D image source unit 100 will be described as a laptop device such as a laptop computer, that employs a first eye view and second eye view information generator 104, memory 106, such as any suitable RAM as desired, a display controller 108, if desired, a single display multi-stream 3D image sender 110 and a single display multi-stream interface 112 (and CPU and other known elements). Blocks 104-112 may be for example, integrated on one or more integrated circuit chips. In one example, the first and second eye view information generator 104 may be a left and right eye frame generator. The first and second eye view information generator 104, display controller 108, single display multi-stream 3D image sender 110 and single display multi-stream interface 112 may be integrated on a single integrated circuit or multiple integrated circuits and may be referred to as a three-dimensional video processing circuit. The functionality may be broken up as desired amongst one or more integrated circuits or discrete components. The multi-eye view information generator 104, such as a left and right eye frame generator in this example, may be a three-dimensional graphics engine operative to generate left and right eye stereoscopic frames from a game application executing for example, on one or more CPU cores (not shown) or may be a 3D stereoscopic video decode system that decodes film or video and transforms the video into stereoscopic first and second eye view information 114 and 116 for the same object such as left and right eye frame information, in this example also labeled 114 and 116, using known techniques. The left eye and right eye frame information 114 and 116 may be stored in memory 106 and then obtained from memory by display controller 108 when the image sender 110 requires the information. As used herein, first and second eye view information may include one stream for color and the other containing polarization information. Any other suitable multiple stream eye view information may be used to facilitate display of a 3D display image.

The single display multi-stream 3D image sender (i.e., transmitter) may be, for example, an image sender that produces multi-stream information including control information, as multi-stream information 118 that is compliant with one or more Display Port specifications. Any other suitable multi-stream frame formatting may also be employed. The single display multi-stream 3D image sender is operative to produce packet based multi-stream information 118 that includes a first stream that includes left eye frame information 114 and a second stream that includes corresponding right eye frame information 116 for display on a single display monitor. The multi-stream 3D image sender 110 also provides control information as part of the multi-stream information wherein the control information indicates that the first and second streams are differing eye views for a single display, as opposed to indicating, for example, that the multi-streams are for multiple displays. The single display multi-stream 3D image sender 110 may receive the control information from, for example, the left and right eye frame generator 104 which is indicated as control information 120 or from any other suitable source such as a CPU or any other suitable control block. The source may also receive control information such as a mode change command to change from a 3D mode to a 2D mode or vice versa and change from outputting 2D information to outputting 3D information or vice versa in real time.

The single display multi-stream interface 112 may be, for example, a connector, cable driver, a wireless transceiver or any other suitable interface that provides a link, e.g., a single set of wires or single channel in a wireless or optical system, to communicate the multi-stream information 118 as the multi-stream information 102. In this example, the single display multi-stream interface 112 may be Display Port compliant.

As shown, the memory 106 stores left eye and right eye frames for a corresponding 3D display frame (stores the left and right eye frame information 114 and 116). The single display multi-stream 3D frame encoder 110 in one example encodes the left eye frame as one stream and the right eye frame information as a separate stream.

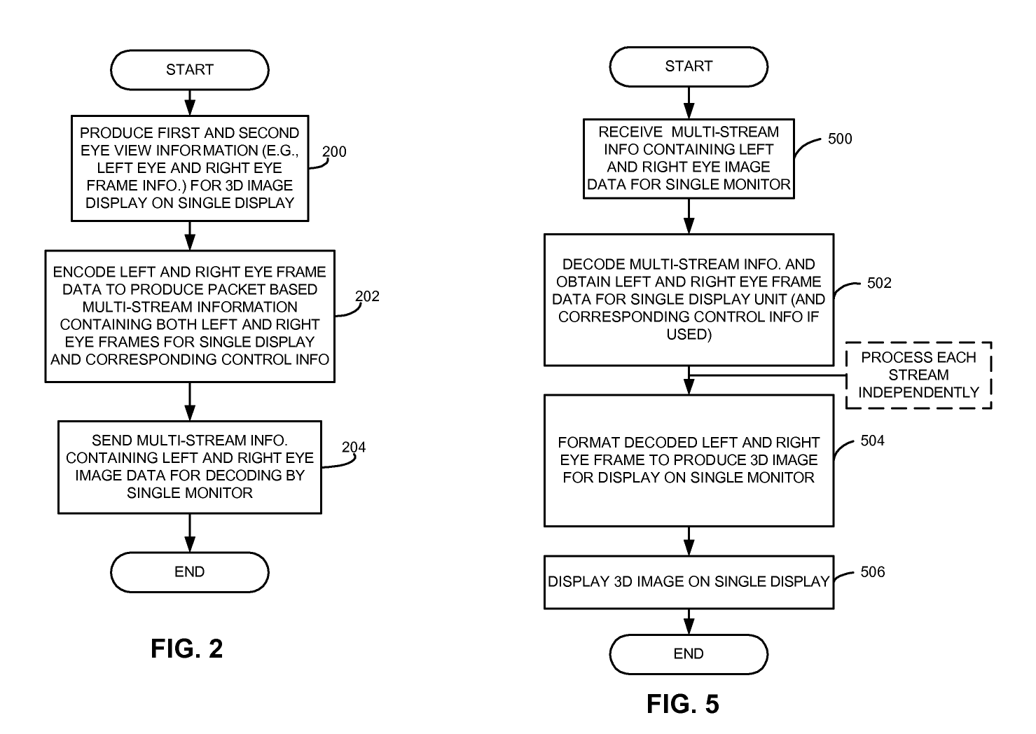

Referring also to FIG. 2, a method is shown that is carried out by one or more source units 100. As shown in block 200, the method includes producing left eye and corresponding right eye frame information for a three-dimensional image. For example, the 3D graphics engine when rendering a game may, for example, be suitably programmed, as known in the art, to produce a left eye frame and corresponding right eye frame for a frame of a 3D game by producing, for example, one stereoscopic left eye frame configured for viewing by a left eye, as well as generating a corresponding right eye frame to be viewed by the right eye of a viewer on a display. This may be done using any known techniques.

The generated left eye and corresponding right eye frame information is then stored in memory and the single display multi-stream 3D image sender 110, as shown in block 202 encodes the left and right frame data to produce packet based multi-stream information that contains both left and right eye frames for a single display. In addition, the encoder provides corresponding control information that is used by the receiving unit so that the receiving unit knows, for example, that certain streams of the multi-stream packet are for one display. For example, The sink device (the receiving unit) declares itself as a display port (DP) branch device and multiple DP sinks, or as a “composite sink” with multiple connected video sinks Since these branch and sink elements are all within the same device, they will share a common “Container ID GUID”. This allows the source device to recognize they all exist within the same physical unit, but the GUID alone does not help with understanding that this is a 3D display that is looking for multiple video streams in parallel to enable 3D viewing.

Either a manual or automated process (e.g., Plug & Play) may be used to allow the single receiving unit (3D display) to switch from a 2D mode to a 3D mode. The source encodes the multiple eye view video streams for the single receiving unit and for the receiving unit to process the received multi-stream information. For the manual setup, the user independently configures the sender and receiver into a 3D display system using any suitable graphic user interface, physical remote control button etc. The multi-eye view information is packetized as a multi-stream packet. Examples of such packets are described in section 2 of the Multi-stream Transport section of the draft DP1.2 specification incorporated herein by reference. However, any suitable packet format may be used. In a manual configuration scheme, the user configures the association between the multiple “display sinks” and the 3D image generation software application running on the source device to setup the 3D display system using a graphic user interface on the device.

For auto configuration via Plug & Play, the method includes the source device understanding that multiple video sinks are all associated with a single 3D display, and which sink is which component of the imagery (e.g. left and right). This can be done via vender specific extensions to any of DPCD, E-EDID, DisplayID or MCCS. By way of example, the source (e.g., 3D monitor) initially enables a single video sink and enables a 2D display mode. The source device queries the abilities of the sink via DPCD, E-EDID, DID, MCCS, etc. protocols to determine if the sink device is capable of 3D display. The source device discovers from the queries that the sink is capable of a 3D display mode. Either right away or at some later point the source device decides to configure for a 3D display mode. This may not happen initially as it might not be needed until a 3D game or application or movie is started by the source. To enable 3D display, the source requests the sink to enable its additional sinks, which the sink does. The source knows which video sinks belong to the 3D display device as they all share a common Container ID GUID. The source uses the Plug & Play information from the sink to determine which type of display information needs to be assigned to each stream number driven to the sink. For example stream 0 is left and stream 1 is right, or stream 0 is color and 1 is polarization. Other options are also possible. Once the sink device receives multiple streams in parallel and is able to create 3D imagery, it switches from 2D display mode to 3D display mode. When the 3D display is no longer desired, the source sends a command to switch back to 2D mode. Alternatively, the source may simply halt all but the initial stream 0 which could automatically cause the display to switch back to 2D mode.

As shown in block 204, the method includes sending the packet based multi-stream information 118 for decoding by a receiving unit. If desired, the method may also include providing control information 120 indicating that the multiple first and second streams are for a single display. This may be provided, for example, by the 3D graphics engine, CPU, or any other suitable component.

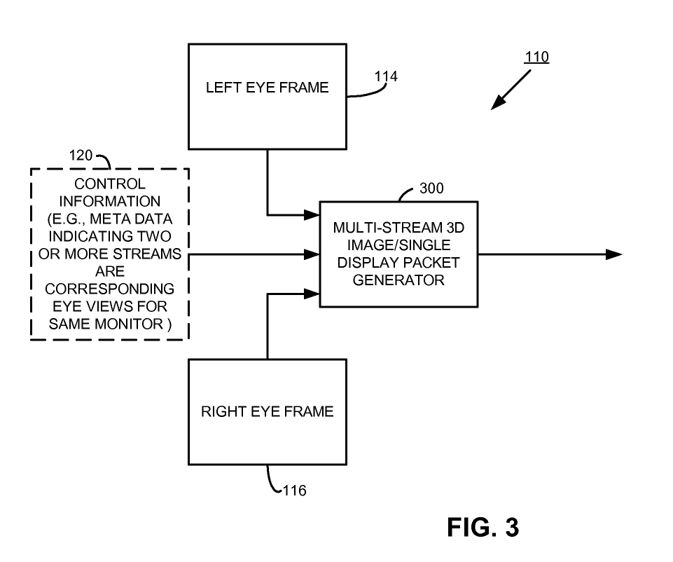

FIG. 3 illustrates in more detail portions of the single display multi-stream 3D image sender 110. The sender 110 includes a multi-stream 3D image single display packet generator 300 that generates packets that contain data representing at least first and second eye views for a same view perspective such as the left eye frame information and corresponding right eye frame information for display on a single display. The multi-stream 3D image single display packet generator 300 may generate packets in compliance with Display Port Specification Version 1.2, or any other suitable format.

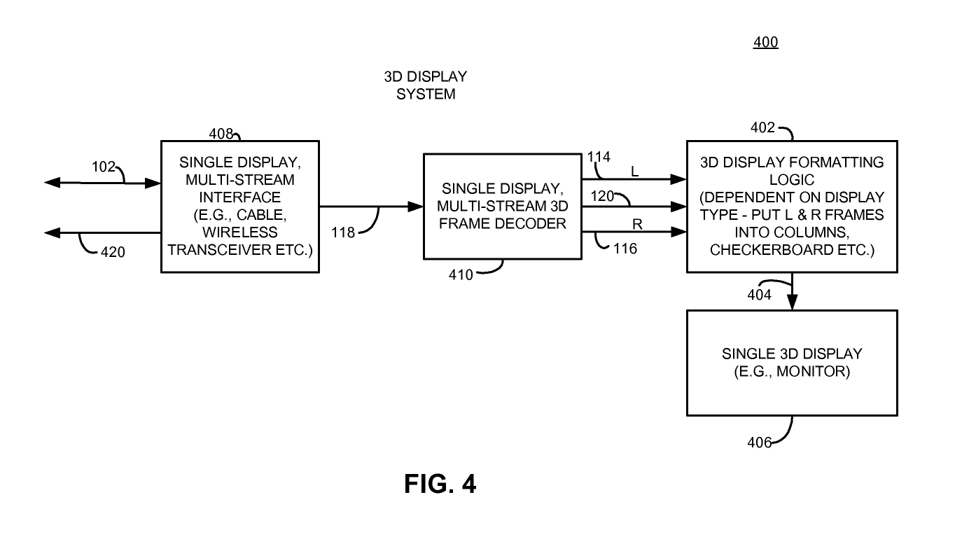

FIG. 4 illustrates a block diagram of an example of a receiving unit 400 that receives the encoded multi-stream stereoscopic display information from the 3D image source unit 100. In this example, the receiving unit may be, for example, a 3D display system that displays 3D movies or games and may include, for example, a work station, high definition television(s), desktop monitor, laptop computer, or any other suitable 3D display system. Although not shown, a video stream or multi-stream hub device, such as a splitter, may be employed between the source unit 100 and the receiving unit 400 so that multiple receiving units (e.g., displays) may receive the multi-stream information 102. In this example, the receiving unit 400 identifies from the packets which streams are to be used for its purposes.

If desired, the receiving unit may format the left and right eye information on its own such that the source unit 100 need not format the left and right frame information. For example, the receiving unit 400 may include a 3D display formatting logic 402 that puts left and right frame eye information into suitable column format, checkerboard format or other suitable format including applying suitable colors or any other formatting required for a polarization 3D display system, or other stereoscopic display system and outputs the information 404 to the single display monitor 406 which may be, for example, a digital display panel. The receiving unit 400 includes a multi-stream interface 408 such as a corresponding connector connected to the cable that is connected to the source unit 100 or a suitable wireless transceiver that receives the multi-stream information. The multi-stream information 118 is then passed to a single display multi-stream 3D image receiver 410 which performs a reverse process on the encoded packets to decode the packets to obtain the left and right eye frame information 114 and 116. The decoder 410 and formatting logic 402 may be any suitable programmed processor, DSP, or any suitable combination of discrete logic as desired to perform the operations described herein. Since each stream contains, in one example, information for a full frame The decoder 410 or logic 402 may perform image enhancement, for example scaling, frame rate conversion or other processing, on each stream before combining the multi-stream information for output as a 3D display. This is different from known system that may precombine information. Due to the full resolution eye view information being sent at the same time, there can be separate image processing on each stream, such as scaling at full resolution, frame rate conversion etc., prior to doing checker board formatting or other combining.

Referring also to FIG. 5, and in operation, the receiving unit 400 receives the multi-stream information containing the left and right eye image data for the single monitor via the interface 408 as shown in block 500. The single display multi-stream 3D image receiver 410 then decodes the packet based multi-stream information 118 wherein the information 118 includes left eye frame information and a second stream comprising corresponding right eye frame information for display on a single display 406. The single display multi-stream 3D image receiver 410 obtains from the encoded information 118 the left eye frame information 114 and corresponding right eye frame information 116. This is shown in block 502. As shown in block 504, the 3D display formatting logic 402 formats the decoded left and right eye frame so that suitable 3D images are displayed on the display. If control information 120 is used, the image receiver decodes the command to determine that two streams in the multi-stream packets are corresponding eye views for the same object(s) and uses the two streams as corresponding 3D image information.

Also if needed, the 3D display formatting logic 402 formats the decoded left and right eye frame information to comply with the format of the 3D display technique used in the receiving unit. For example, the format may be columns of information, checkerboard patterns between left and right eye frame information, alternating lines, or any other suitable stereoscopic formatting requirements so that when the decoded left and right eye frame information is displayed on the display 506, a 3D video is perceived by a viewer.

Also, integrated circuit design systems (e.g. work stations) are known that create integrated circuits based on executable instructions stored on a computer readable memory such as but not limited to CDROM, RAM, other forms of ROM, hard drives, distributed memory etc. The instructions may be represented by any suitable language such as but not limited to hardware descriptor language or other suitable language. As such, the logic (e.g., circuits) described herein may also be produced as integrated circuits by such systems. For example an integrated circuit may be created for use in a display system using instructions stored on a computer readable medium that when executed cause the integrated circuit design system to create an integrated circuit that is operative to produce packet based multi-stream information that includes at least a first stream comprising left eye frame information and a second stream comprising corresponding right eye frame information for display on a single display and operative to provide control information indicating that the first and second streams are for a single display. Integrated circuits having the logic that performs other of the operations described herein may also be suitably produced.

The above detailed description of the invention and the examples described therein have been presented for the purposes of illustration and description only and not by limitation. For example multiple eye views may include more a right and left stereoscopic pair. It will be recognized that the above operations may be applied to differing types of 3D systems such as those that employ shutter glasses and other systems. It is therefore contemplated that the present invention cover any and all modifications, variations or equivalents that fall within the spirit and scope of the basic underlying principles disclosed above and claimed herein.

What is claimed is:

1. A three dimensional video processing circuit comprising:
a multi-stream 3D image sender operative to produce, for a single link, packet based multi-stream information comprising a first stream comprising at least first eye view information and a second stream comprising corresponding second eye view information for display on a single display, wherein each stream comprises a same object viewed from differing view perspectives.

2. The three dimensional video processing circuit of claim 1 wherein the encoder is operative to provide control information indicating that the at least first and second streams are for the single display.

3. The three dimensional video processing circuit of claim 1 wherein the first and second eye view information comprises left eye frame information and right eye frame information and where in the circuit comprises a left eye and right eye frame generator operative to produce the left eye frame information and corresponding right eye frame information for a 3D display image for the single display.

4. The three dimensional video processing circuit of claim 2 being operative to provide the control information as part of the packet based multi-stream information.

5. A method carried out by one or more devices comprising:
producing at least first eye view and corresponding second eye view information for a three dimensional image;
producing, for a single link, packet based multi-stream information comprising a first stream comprising the first eye view information and a second stream comprising corresponding second eye view information for display on a single display, wherein each stream comprises a same object viewed from differing view perspectives.

6. The method of claim 5 wherein the first and second eye view information comprises left eye frame information and right eye frame information and wherein the method comprises producing the left eye frame information and corresponding right eye frame information for a 3D display frame for the single display.

7. The method of claim 5 comprising:
receiving, from a display, data representing a 3D display capability of the display and wherein the producing first and corresponding second eye view information for a three dimensional image is done in response to the data representing the 3D display capability of the display.

8. The method of claim 5 comprising providing control information indicating that multiple first and second streams are for a single display.

9. A three dimensional video processing circuit comprising:
a multi-stream 3D image receiver operative to process packet based multi-stream information from a single link comprising at least a first stream comprising first eye view information and a second stream comprising corresponding second eye view information for display on a single display, wherein each stream comprises a same object viewed from differing view perspectives; and
three dimensional image formatting logic operative to combine the processed first eye view information and corresponding second eye view information to produce a 3D display.

10. The circuit of claim 9 wherein the three dimensional frame formatting logic is operative to format the processed first eye view information and corresponding second eye view information by arranging decoded left eye frame information and right eye information into any one of at least corresponding: checkerboard patterns, alternating column patterns, alternating lines or alternating frame patterns.

11. The circuit of claim 10 operative to send control information representing a 3D display capability of the display.

12. The circuit of claim 9 wherein the receiver is operative to process received control information indicating that the first and second streams are used for displaying a 3D image of a same object viewed from differing view perspectives.

13. A method by one or more devices comprising:
decoding packet based multi-stream information from a single link comprising at least a first stream comprising first eye view information and a second stream comprising corresponding second eye view information for display on a single display to produce therefrom a 3D display wherein each stream comprises a same object viewed from differing view perspectives; and
combining the at least first eye view information and corresponding second eye view information for a 3D display.

14. The method of claim 13 comprising formatting the first eye view information and corresponding second eye view information by arranging first and second eye view information into any one of at least corresponding: checkerboard patterns, alternating column patterns, alternating lines or alternating frame patterns.

15. A display unit comprising
a display; and
a three dimensional video processing circuit, operatively coupled to the display, comprising:
a multi-stream 3D image receiver operative to process packet based multi-stream information from a single link comprising at least a first stream comprising first eye view information and a second stream comprising corresponding second eye view information for display on the display, wherein each stream comprises a same object viewed from differing view perspectives; and
three dimensional frame formatting logic, operatively coupled to the display, and operative to combine the first eye view information and corresponding second eye view information for 3D display on the display.

16. The display unit of claim 15 wherein the three dimensional frame formatting logic is operative to format first eye view information and corresponding second eye view information by arranging first and second eye view information into any one of at least corresponding: checkerboard patterns, alternating column patterns, alternating lines or alternating frame patterns.

17. The display unit of claim 16 wherein the 3D video processing circuit is operative to send control information representing a 3D display capability of the display unit and wherein the video processing circuit is operative to process received control information indicating that the first and second streams are used for displaying a 3D image of a same object viewed from differing view perspectives.

18. A method carried out by one or more devices comprising:
producing left eye and corresponding right eye frame information for a three dimensional image;
producing packet based multi-stream information, for a single link, comprising a first stream comprising the left eye frame information and a second stream comprising corresponding right eye frame information for display on a single display, wherein each stream comprises a same object viewed from differing view perspectives;
decoding packet based multi-stream information, from the single link, comprising at least a first stream comprising left eye frame information and a second stream comprising corresponding right eye frame information for display on a single display to produce therefrom decoded left eye frame information and corresponding right eye frame information; and
combining the decoded left eye frame information and corresponding right eye frame information for a 3D display effect.

19. The method of claim 18 comprising providing control information indicating that multiple first and second streams are for a single display unit;
sending the packet based multi-stream information and the control information for decoding; and
displaying the first and second streams on a single display.

20. The method of claim 19 comprising receiving, from a display unit, control information representing a 3D display capability of the display unit and wherein the producing left eye and corresponding right eye frame information for a three dimensional image is done in response to the data representing the 3D display capability of the display unit.
